(19) United States
(12) Patent Application Publication
(10) Pub. No.: US 2014/0350983 A1
(43) Pub. Date: Nov. 27, 2014

(54) PROVIDING BEST PRACTICE WORKFLOW TO AID USER IN COMPLETING PROJECT THAT IS CONSTANTLY UPDATED BASED ON USER FEEDBACK

(71) Applicant: International Business Machines Corporation, Armonk, NY (US)

(72) Inventors: Geetika T. Lakshmanan, Winchester, MA (US); Martin Oberhofer, Bondorf (DE)

(73) Assignee: International Business Machines Corporation, Armonk, NY (US)

(21) Appl. No.: 13/901,781

(22) Filed: May 24, 2013

Related U.S. Application Data
(63) Continuation of application No. 13/900,770, filed on May 23, 2013.

(51) Int. Cl. G06Q 10/06

(52) U.S. Cl. CPC G06Q 10/063114
USPC 705/7.15

(57) ABSTRACT

A method, system and computer program product for providing a best practice workflow to aid a user in completing a project. A system receives practice instances for completing a project (e.g., obtaining a job), where a “practice instance” refers to a graph of nodes and directed edges, where each node represents a task in a process for completing the project and each directed edge illustrates an execute sequence between two tasks. The system receives rankings from users (“crowdsourcing”) for each of these practice instances and computes a single ranking for each practice instance based on these received rankings. The system may then generate a workflow for completing a project based on these practice instances with a single ranking that exceeds a threshold and are directed to completing the same project. By using user feedback to rank these practice instances, a more effective and useful workflow will be generated.

### CROSS-REFERENCE TO RELATED APPLICATIONS

The present application is a continuation application of pending U.S. patent application Ser. No. 13/900,770, which was filed on May 23, 2013, which is assigned to the assignee of the present invention. The present application claims priority benefits to U.S. patent application Ser. No. 13/900,770.

### TECHNICAL FIELD

The present invention relates generally to workflows, and more particularly to providing a best practice workflow to aid the user in completing a project (e.g., applying for a job) that is constantly updated based on feedback from other users.

### BACKGROUND

A workflow may refer to the process used in completing a project (e.g., obtaining a visa to travel to a particular foreign country), where the process includes tasks (e.g., determine type of visa based on length of stay) to be accomplished in order to complete the project. Such workflows may appear in graphical form, such as in a flowchart form, to the user to aid the user in understanding the tasks or steps that need to be completed.

Currently, however, such workflows are generated based on a single user's perceived notion of what is the best practice for completing that project. These workflows are not generated based on input from other users (“crowdsourcing”), such as online users. As a result, the effectiveness or usefulness of such workflows in completing the desired project may be lacking as the author of the workflow may not have knowledge of the best process in completing the project. Furthermore, these workflows are not able to be updated with a better process for completing the project, such as may be provided from other users.

Hence, the current workflows that are provided to users for completing a project may not be the best process for completing the desired project.

### BRIEF SUMMARY

In one embodiment of the present invention, a method for providing a best practice workflow to aid a user in completing a project comprises receiving practice instances for completing the project from a first plurality of users, where each of the practice instances comprises a graph of nodes and directed edges. Furthermore, each of the nodes represents a task in a process for completing the project and each of the directed edges illustrates an execution sequence between two tasks. The method further comprises receiving a plurality of rankings for each of the practice instances from a second plurality of users. The method additionally comprises computing a single ranking for each of the practice instances based on the received rankings from the second plurality of users. In addition, the method comprises generating, by a processor, the best practice workflow for completing the project based on practice instances whose single ranking exceeds a threshold, where the best practice workflow comprises a plurality of tasks in the process for completing the project and edges between tasks indicating control flow between the tasks.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a network system configured in accordance with an embodiment of the present invention;

FIG. 2 illustrates a hardware configuration of a best practice workflow system in accordance with an embodiment of the present invention;

FIG. 3 is a flowchart of a method for generating a workflow to aid a user in completing a project that is constantly updated based on feedback from the users in accordance with an embodiment of the present invention;

FIG. 4 illustrates a sample best practice workflow for obtaining a job in the chemical engineering industry in accordance with an embodiment of the present invention;

FIG. 5 illustrates an uploaded practice instance for obtaining a job in the chemical engineering industry in accordance with an embodiment of the present invention;

FIG. 6 illustrates updating the best practice workflow of FIG. 4 for obtaining a job in the chemical engineering industry in light of the uploaded practice instance of FIG. 5 in accordance with an embodiment of the present invention; and

FIG. 7 is a flowchart of a method for providing recommendations to a user as to the next tasks or steps to be accomplished in completing a project based on the best practice workflow for completing that project in accordance with an embodiment of the present invention.

### DETAILED DESCRIPTION

The present invention comprises a method, system and computer program product for providing a best practice workflow to aid a user in completing a project. In one embodiment of the present invention, a system, referred to herein as the “best practice workflow system,” receives practice instances for completing a project (e.g., obtaining a job). A “practice instance,” as used herein, refers to a graph of nodes and directed edges, where each node represents a task in a process for completing the project and each directed edge illustrates an execute sequence between two tasks. The best practice workflow system receives rankings from users (“crowdsourcing”) for each of these practice instances. The best practice workflow system computes a single ranking for each practice instance based on these received rankings from the users. For example, the single ranking may be computed based on the weighted average of all the user rankings, where each user's ranking is given equal weight. The best practice workflow system may then generate a best practice workflow for completing a project, such as by using a process mining technique, based on these practice instances with a single ranking that exceeds a threshold and are directed to completing the same project. A “best practice workflow,” as used herein, refers to a process used in completing a project (e.g., obtaining a job in the chemical engineering industry), where the process includes tasks to be accomplished in order to complete the project. By using user feedback (“crowdsourcing”) to rank these practice instances, a more effective and useful best practice workflow will be generated. Furthermore, the generated best practice workflow may be constantly updated by further submitted practice instances with a ranking that exceeds a threshold thereby providing the best workflow with the best process to assist the user in completing the project.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

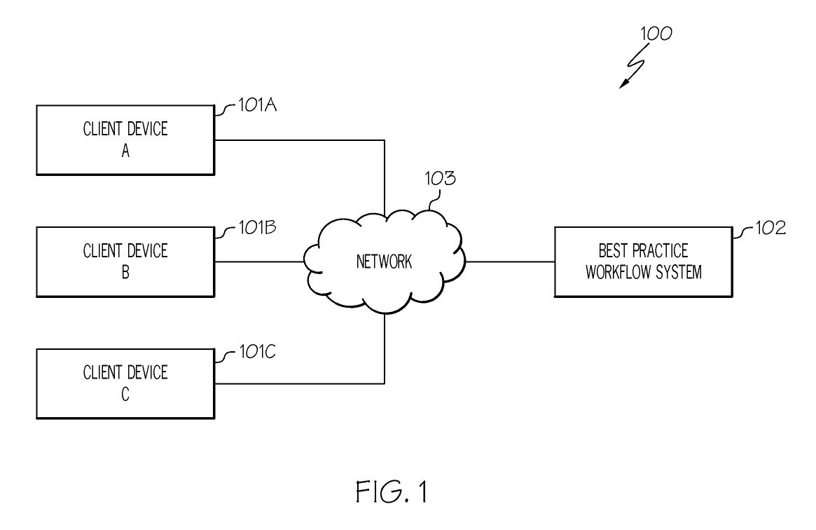

Referring now to the Figures in detail, FIG. 1 illustrates a network system 100 for practicing the principles of the present invention in accordance with an embodiment of the present invention. Network system 100 includes client devices 101A-101C (identified as “Client Device A,” “Client Device B,” and “Client Device C,” respectively, in FIG. 1) connected to a system (referred to herein as the “best practice workflow system”) 102 via a network 103. Client devices 101A-101C may collectively or individually be referred to as client devices 101 or client device 101, respectively. Client device 101 may be any type of computing device (e.g., portable computing unit, Personal Digital Assistant (PDA), smartphone, laptop computer, mobile phone, navigation device, game console, desktop computer system, workstation, Internet appliance and the like) configured with the capability of connecting to network 103 and consequently communicating with other client devices 101 and best practice workflow system 102.

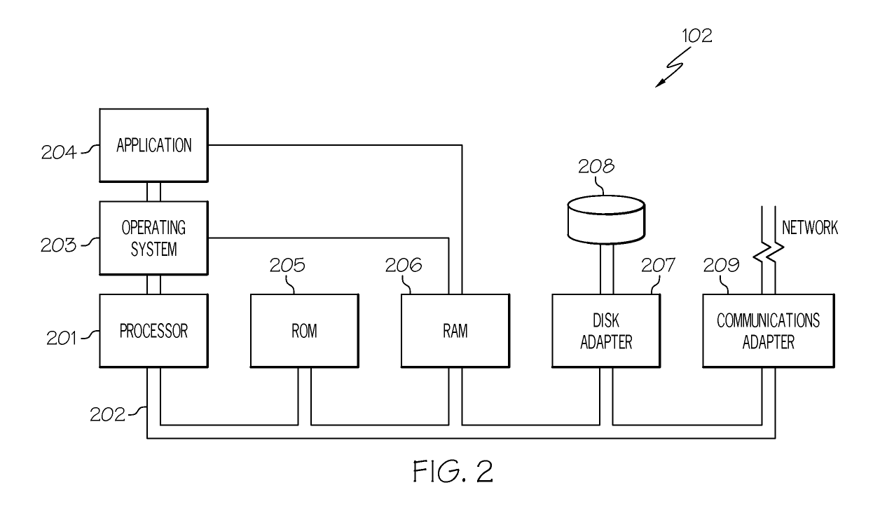

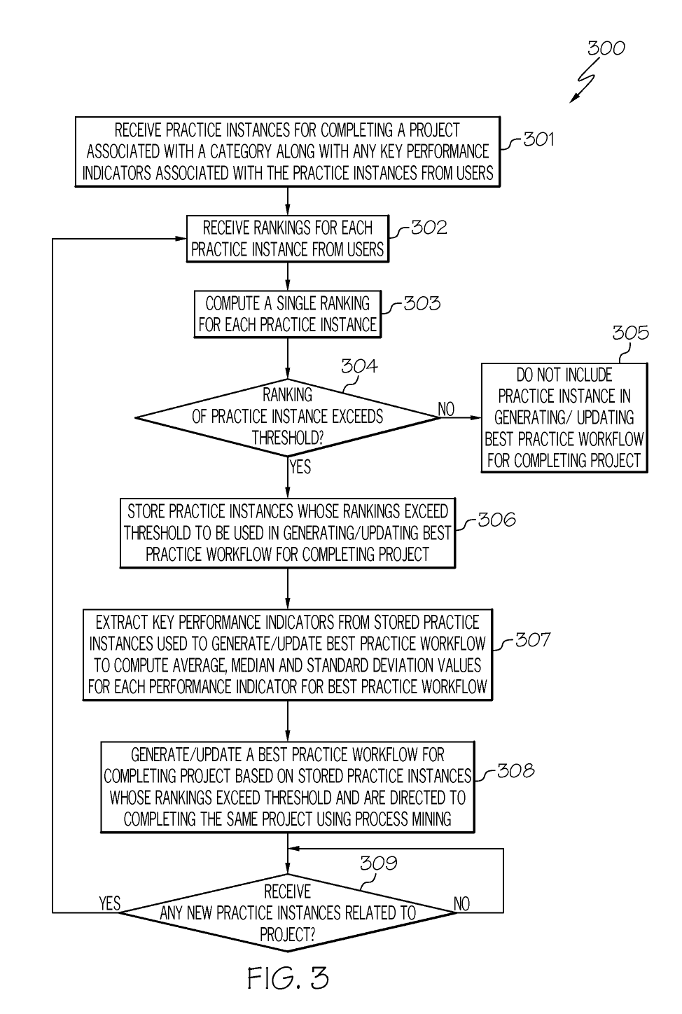

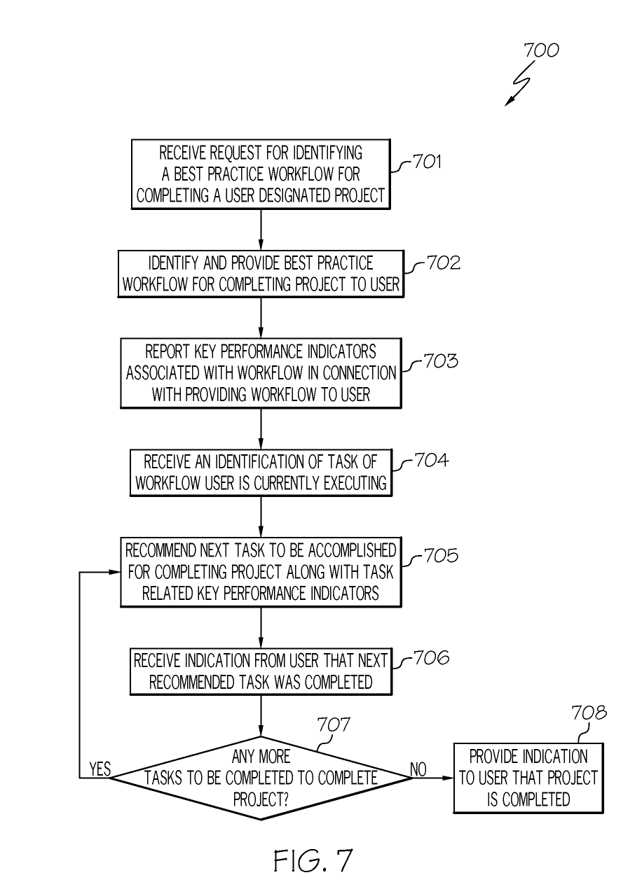

In one embodiment, best practice workflow system 102 is configured to generate a best practice workflow to aid a user in completing a project (e.g., obtaining a job) that is constantly updated based on feedback from the users of client devices 101 as discussed further herein in connection with FIGS. 3-6. As used herein, a “best practice workflow” refers to a process in completing a project, where the process includes tasks that represent the steps in completing the project. Furthermore, the best practice workflow includes edges between tasks indicating control flow between the tasks. In one embodiment, the workflow may appear in graphical form, such as in flowchart form. Furthermore, best practice workflow system 102 is configured to provide recommendations to a user of client device 101 as to the next tasks or steps to be accomplished in completing a project based on the best practice workflow for completing that project as discussed further herein in connection with FIG. 7. A description of the hardware configuration of best practice workflow system 102 is provided below in connection with FIG. 2.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

While FIG. 1 illustrates three clients 101A-101C and a single best practice workflow system 102, network system 100 may include any number of clients 101 and systems 102. The embodiments of network system 100 are not to be limited in scope to the depiction of FIG. 1.

Referring now to FIG. 2, FIG. 2 illustrates a hardware configuration of best practice workflow system 102 (FIG. 1) which is representative of a hardware environment for practicing the present invention. System 102 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a program for generating a best practice workflow to aid a user in completing a project (e.g., obtaining a job) that is constantly updated based on feedback from the users of client devices 101 (FIG. 1) as discussed further below in association with FIGS. 3-6, a program for providing recommendations to a user of client device 101 as to the next tasks or steps to be accomplished in completing a project based on the best practice workflow for completing that project as discussed further below in association with FIG. 7.

Referring again to FIG. 2, read-only memory (“ROM”) 205 is coupled to system bus 202 and includes a basic input/output system (“BIOS”) that controls certain basic functions of system 102. Random access memory (“RAM”) 206 and disk adapter 207 are also coupled to system bus 202. It should be noted that software components including operating system 203 and application 204 may be loaded into RAM 206, which may be system's 102 main memory for execution. Disk adapter 207 may be an integrated drive electronics (“IDE”) adapter that communicates with a disk unit 208, e.g., disk drive. It is noted that the program for generating a best practice workflow to aid a user in completing a project (e.g., obtaining a job) that is constantly updated based on feedback from the users of client devices 101, as discussed further below in association with FIGS. 3-6, may reside in disk unit 208 or in application 204. Furthermore, it is noted that the program for providing recommendations to a user of client device 101 as to the next tasks or steps to be accomplished in completing a project based on the best practice workflow for completing that project, as discussed further below in association with FIG. 7, may reside in disk unit 208 or in application 204.

System 102 may further include a communications adapter 209 coupled to bus 202. Communications adapter 209 interconnects bus 202 with an outside network (e.g., network 103 of FIG. 1) thereby enabling system 102 to communicate with client device 101.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, currently, workflows are generated based on a single user's perceived notion of what is the best practice for completing that project. These workflows are not generated based on input from other users (“crowdsourcing”), such as online users. As a result, the effectiveness or usefulness of such workflows in completing the desired project may be lacking as the author of the workflow may not have knowledge of the best process in completing the project. Furthermore, these workflows are not able to be updated with a better process for completing the project, such as may be provided from other users. Hence, the current workflows that are provided to users for completing a project may not be the best process for completing the desired project.

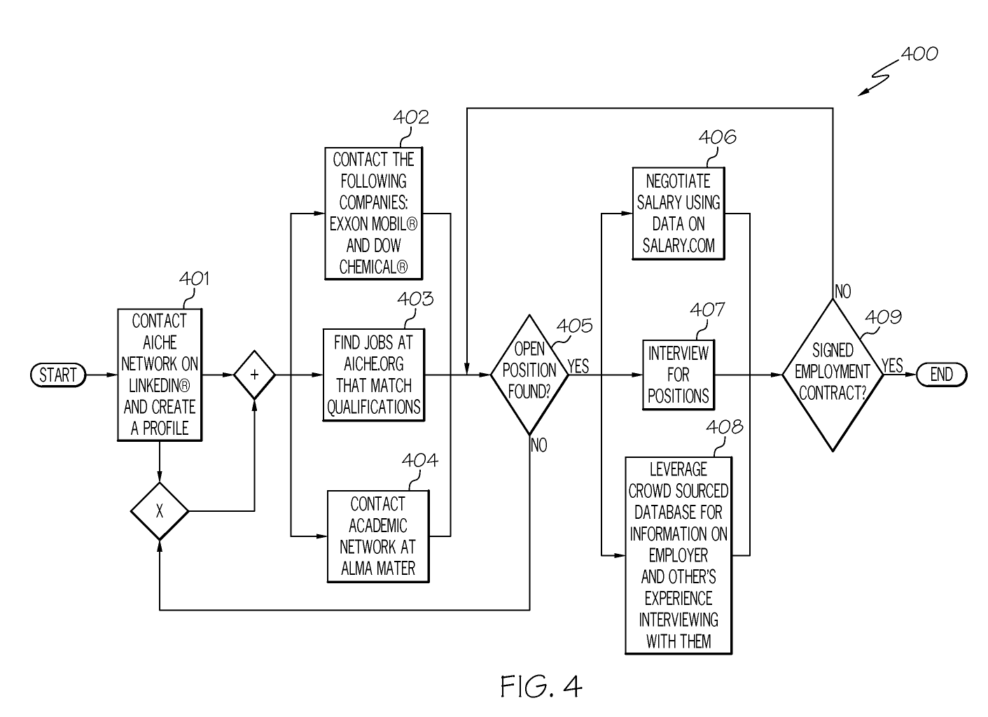

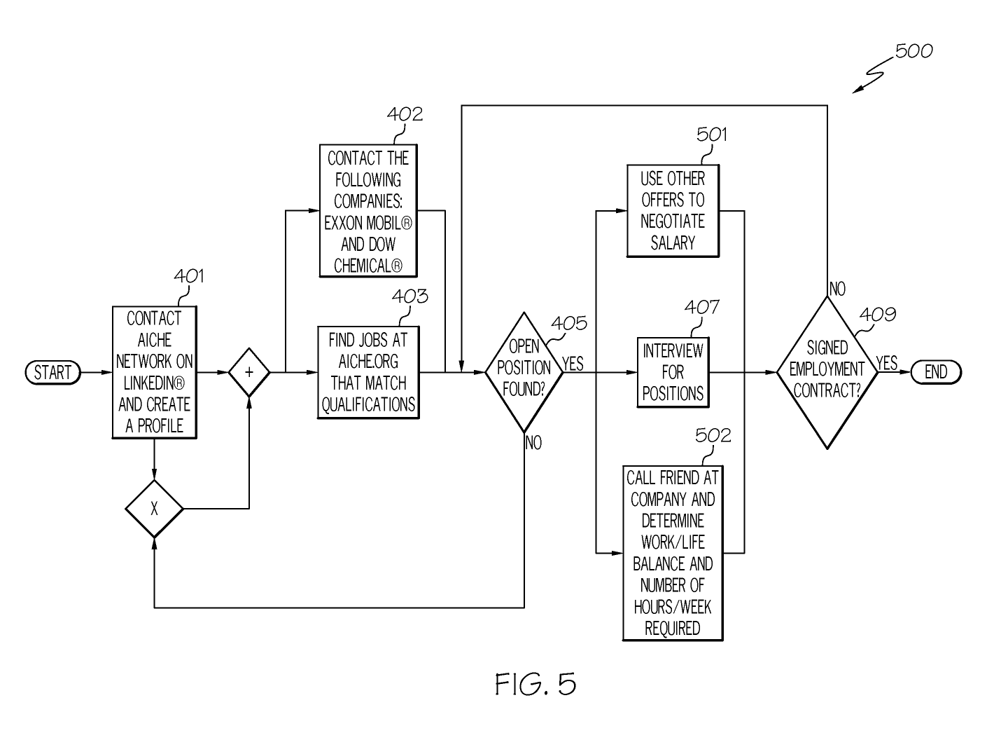

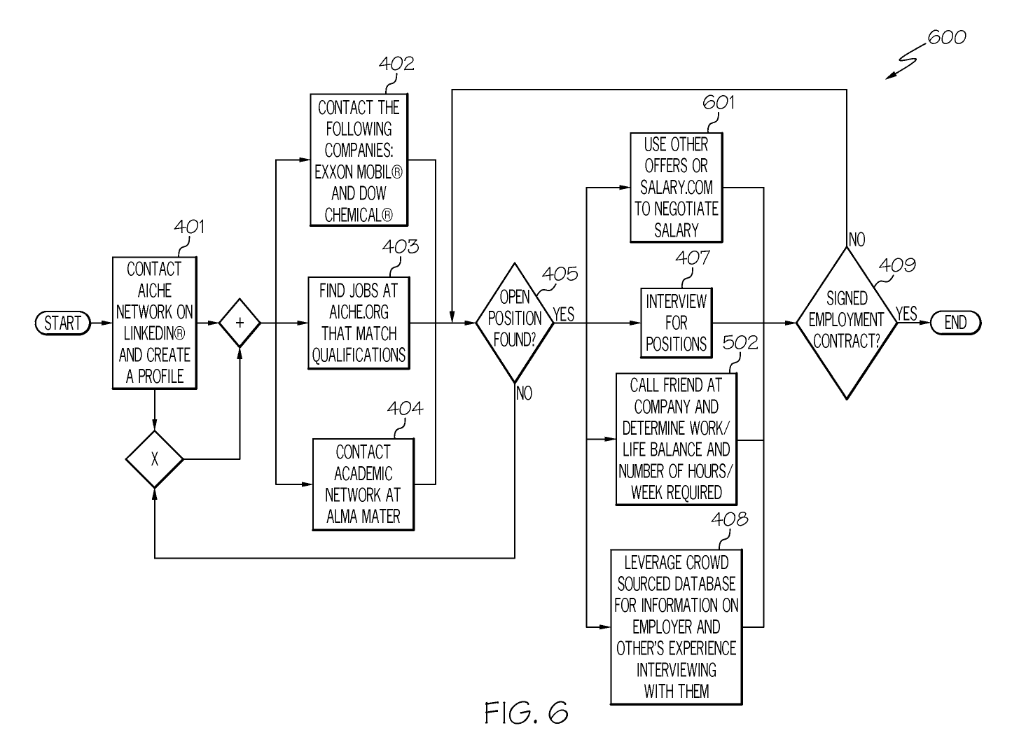

The principles of the present invention provide a means for generating a workflow to aid a user in completing a project (e.g., obtaining a job) that is constantly updated based on feedback from other users thereby providing the best workflow with the best process to assist the user in completing the project as discussed further below in connection with FIGS. 3-6. Furthermore, the principles of the present invention provide a means for providing recommendations to the user as to the next tasks or steps to be accomplished in completing a project based on the workflow for completing that project as discussed further below in connection with FIG. 7. FIG. 3 is a flowchart of a method for generating a workflow to aid a user in completing a project that is constantly updated based on feedback from the users of client devices 101 (FIG. 1). FIG. 4 illustrates a sample best practice workflow for obtaining a job in the chemical engineering industry. FIG. 5 illustrates an uploaded practice instance for obtaining a job in the chemical engineering industry. FIG. 6 illustrates updating the best practice workflow of FIG. 4 for obtaining a job in the chemical engineering industry in light of the uploaded practice instance of FIG. 5. FIG. 7 is a flowchart of a method for providing recommendations to a user of client device 101 as to the next tasks or steps to be accomplished in completing a project based on the best practice workflow for completing that project.

As stated above, FIG. 3 is a flowchart of a method 300 for generating a workflow to aid a user in completing a project that is constantly updated based on feedback from the users of client devices 101 (FIG. 1) in accordance with an embodiment of the present invention.

Referring to FIG. 3, in conjunction with FIGS. 1-2, in step 301, best practice workflow system 102 receives practice instances for completing a project (e.g., obtaining a job) associated with a category along with any key performance indicators associated with the practice instances from the users of client devices 101. A “practice instance,” as used herein, refers to a graph of nodes and directed edges, where each node represents a task in a process for completing the project and each directed edge illustrates an execute sequence between two tasks. A “key performance indicator,” as used herein, refers to an indicator that is used to assess the performance in completing the project. Such key performance indicators are tailored for the project in question. Examples of key performance indicators include, but not limited to, a time to completion, an end to end monetary cost, hours of travel required, probability of success, out of pocket expense, etc. Furthermore, it is noted that the key performance indicators may be associated with the tasks themselves that are used in the process for completing the project. That is, one or more of the tasks in a practice instance (as well as one or more of the tasks in a best practice workflow as discussed further below) may be associated with a key performance indicator.

In one embodiment, the practice instance along with its key performance indicators are uploaded to best practice workflow system 102 by a user of client device 101 under an existing category or a new category defined by the user. For example, a user of client device 101 may upload a practice instance to best practice workflow system 102 for obtaining a job in the chemical engineering industry. If the user does not identify a category related to obtaining a job in the chemical engineering industry, then the user may create a category for this practice instance. In one embodiment, the practice instance can be uploaded through a diagram based widget.

In step 302, best practice workflow system 102 receives rankings from the users of client devices 101 for each practice instance. In one embodiment, best practice workflow system 102 makes available the received practice instances to be evaluated or “ranked” by other users (“crowdsourcing”) thereby providing a mechanism for receiving feedback from the users of client devices 101 regarding the effectiveness or usefulness of such practice instances in completing a project. By using user feedback (“crowdsourcing”) to rank these practice instances, a more effective and useful best practice workflow will be generated as discussed below.

In step 303, best practice workflow system 102 computes a single ranking for each practice instance based on the received rankings from the users. For example, the single ranking may be computed based on the weighted average of all the user rankings, where each user's ranking is given equal weight.

For each practice instance receiving a computed ranking in step 303, a determination is made, in step 304, by best practice workflow system 102 as to whether the single ranking for the practice instance (ranking in step 303) exceeds a threshold.

If the single ranking for the practice instance does not exceed the threshold, then, in step 305, best practice workflow system 102 does not include such a practice instance in generating/updating the best practice workflow for completing the project (the aspect of generating/updating the best practice workflow for completing the project is discussed in further detail below).

If, however, the single ranking for the practice instance does exceed the threshold, then, in step 306, best practice workflow system 102 stores those practice instances with a ranking (ranking of step 303) that exceeds the threshold. In one embodiment, the practice instances may be stored as a finite set of practice instances. As a result, when the set of stored practice instances has reached its maximum size, the oldest practice instance or the lowest ranked practice instance may be removed from the set of practice instances to make room for a newly added practice instance. Practice instances may be continuously added to the set as best practice workflow system 102 continues to receive practice instances from the users of client devices 101 with rankings that exceed the threshold as discussed further below. In this manner, the best practice workflow for completing the project can be updated with a better process for completing the project.

In step 307, best practice workflow system 102 extracts the key performance indicators from the stored practice instances (e.g., the stored set of practice instances) that will be used to generate/update the best practice workflow to compute one or more of the following: an average, median and standard deviation values for each of the extracted key performance indicators for the best practice workflow. As will be discussed in greater detail below, a best practice workflow, as used herein, refers to a process used in completing a project (e.g., obtaining a job in the chemical engineering industry), where the process includes tasks to be accomplished in order to complete the project. The best practice workflow for a project is generated/updated using the stored practice instances (those stored in step 306) for completing the same project as discussed below.

In step 308, best practice workflow system 102 generates/updates a best practice workflow for completing a project based on the stored practice instances (those stored in step 306) whose rankings exceed the threshold and are directed to completing the same project. In one embodiment, the best practice workflow is generated/updated using a process mining technique. The process mining technique mines a workflow that represents an aggregate view of the best practice instance in that category. Examples of such process mining techniques include the process mining algorithms discussed in the reference entitled “Leveraging Process Mining Techniques to Analyze Semi-Structured Processes,” Geetika T. Lakshmanan and Rania Khalaf, IT Professional, IEEE Computer Society, Aug. 24, 2012, which is incorporated herein by reference in its entirety. An example of a best practice workflow that is generated based on the stored practice instances (those stored in step 306) using a process mining technique is provided in FIG. 4.

FIG. 4 illustrates a sample best practice workflow 400 for obtaining a job in the chemical engineering industry in accordance with an embodiment of the present invention. Referring to FIG. 4, best practice workflow 400 includes the task 401 of contacting the American Institute for Chemical Engineers (AICHE) network on LinkedIn® and creating a profile. After this task is accomplished, the user has an option to perform one or more of the tasks in tasks 402-404 (task 402 corresponds to contacting various companies, such as Exxon Mobil® and Dow Chemical®; task 403 corresponds to finding jobs at www.AICHE.org that match qualifications; and task 404 corresponds to contacting the academic network at the user's alma mater). Upon completion of one or more of these tasks (tasks 402-404), a determination is made in step/task 405 as to whether an open position is found. If an open position is not found, then the user is directed to perform one or more of tasks 402-404. If, however, an open position is found, then one or more various tasks may be accomplished as indicated in tasks 406-408 (task 406 corresponds to negotiating a salary using data on www.salary.com; task 407 corresponds to interviewing for the position; and task 408 corresponds to leveraging a crowd sourced database for information on the employer and users' experiences in interviewing with the employer, where a crowd sourced database refers to a database of information populated by other users directed to the employer and interviewing with the employer). Upon completion of one or more of these tasks (tasks 406-408, a determination is made in step/task 409 as to whether an employment contract has been signed. If so, then the project is completed. That is, the goal in obtaining a job in the chemical engineering industry is accomplished. If, however, an employment contract has not been signed, then the user is returned to task 405 to determine if an open position is found.

In one embodiment, the extracted key performance indicators (discussed above in connection with step 307) are reported in conjunction with the best practice workflow when it is displayed to the user as discussed further below in connection with FIG. 7. For example, the key performance indicators for best practice workflow 400 may be that an average job was successfully found in 90 days using workflow 400, an average out of pocket expense spent on the job search was between $100-$200 using workflow 400 and that the average number of days for travel required for job hunting using workflow 400 was 2-3 days. It is noted that key performance indicators may also be reported for the tasks themselves in workflow 400.

As discussed above, the best practice workflow can be continuously updated based on practice instances whose feedback exceeds a threshold. In this manner, the best practice workflow can be updated with a better process for completing the project as discussed below in connection with step 309.

In step 309, a determination is made by best practice workflow system 102 as to whether another practice instance is received related to the project in question (e.g., obtaining a job in the chemical engineering industry). If another practice instance is not received, then best practice workflow system 102 continues to wait to receive another practice instance related to the project in question.

If, however, another practice instance is received related to the project in question, then best practice workflow system 102 makes available that practice instance for feedback from the users of client devices 101 (“crowdsourcing”) regarding the effectiveness or usefulness of such a practice instance in completing the project. As a result, practice workflow system 102 receives rankings from the users of client devices 101 for that practice instance in step 302. An example of another uploaded practice instance that is related to the project in question (e.g., obtaining a job in the chemical engineering industry) is provided in connection with FIG. 5.

FIG. 5 illustrates an uploaded practice instance 500 for obtaining a job in the chemical engineering industry in accordance with an embodiment of the present invention. Referring to FIG. 5, practice instance 500 includes the same tasks as best practice workflow 400 of FIG. 4 (identified by the same reference numerals as used in the description of best practice workflow 400) except for the following noted tasks.

Practice instance 500 differs from best practice workflow 400 because the user used other offers to negotiate their salary (see task 501); called a friend at the company to determine work/life balance and number of hours required per week for the position (see task 502); and the user did not contact the academic network at the user's alma mater as suggested by best practice workflow 400. The performance indicators that may be provided by the user with the uploaded practice instance, such as practice instance 500, may include key performance indicators, such as having the job successfully found in 160 days; having the out of pocket expense spent on the job search being less than $100 and having the number of days for travel required for job hunting being between 5-10 days.

Returning to FIG. 3, in conjunction with FIGS. 1-2 and 4-5, if the computing single ranking for this practice instance based on the rankings received from the users of client devices 101 exceeds a threshold, then such a practice instance is stored in step 306, which may involve adding the practice instance to the stored set of practice instances resulting in the removal of the oldest practice instance or the lowest ranked practice instance from the set of practice instances. After updating the set of stored practice instances, key performances indicators are extracted from the set of practice instances. Furthermore, after updating the set of stored practice instances, the best practice workflow for the project is updated using the updated set of stored practice instances, such as using a process mining technique, as discussed above in connection with step 308 and illustrated in FIG. 6.

FIG. 6 illustrates updating the best practice workflow 400 of FIG. 4 for obtaining a job in the chemical engineering industry in light of the uploaded practice instance of FIG. 5 in accordance with an embodiment of the present invention.

Referring to FIG. 6, best practice workflow 600 includes the same tasks as best practice workflow 400 of FIG. 4 (identified by the same reference numerals as used in the description of best practice workflow 400) except for the following noted tasks.

As illustrated in FIG. 6, best practice workflow 600 now includes the task 601 directed to using other offers or www.salary.com to negotiate a salary as well as includes task 502 from practice instance 500 of FIG. 5. Furthermore, the key performance indicators are updated based on the new set of stored practice instances used to update best practice workflow 400 to become best practice workflow 600. For example, the new key performance indicators for best practice workflow 600 may be that an average job was successfully found in 100 days using workflow 600, an average out of pocket expense spent on the job search was between $100-$200 using workflow 600 and that the average number of days for travel required for job hunting using workflow 600 was 3-4 days.

In some implementations, method 300 may include other and/or additional steps that, for clarity, are not depicted. Further, in some implementations, method 300 may be executed in a different order presented and that the order presented in the discussion of FIG. 3 is illustrative. Additionally, in some implementations, certain steps in method 300 may be executed in a substantially simultaneous manner (e.g., steps 307 and 308 may be executed in parallel) or may be omitted.

Once a best practice workflow for a project has been generated, a user may be able to access the best practice workflow to assist the user in completing that project. In connection with assisting the user in completing the project, best practice workflow system 102 may provide recommendations to the user as to the next tasks or steps to be accomplished in completing a project based on the task of the workflow the user is currently executing as discussed below in connection with FIG. 7.

FIG. 7 is a flowchart of a method 700 for providing recommendations to a user of client device 101 (FIG. 1) as to the next tasks or steps to be accomplished in completing a project based on the best practice workflow for completing that project in accordance with an embodiment of the present invention.

Referring to FIG. 7, in conjunction with FIGS. 1-6, in step 701, best practice workflow system 102 receives a request from a user of client device 101 for identifying a best practice workflow for completing a user designated project. In one embodiment, best practice workflow system 102 stores best practice workflows under various categories for completing various projects.

In step 702, best practice workflow system 102 identifies and provides to the user of client device 101 the best practice workflow for completing the user-designated project. In one embodiment, best practice workflow system 102 can identify the appropriate best practice workflow to provide to the user by matching the user-designated project with one of the categories storing best practice workflows. For example, if the user requests the best practice workflow for obtaining a job in the chemical engineering industry, then best practice workflow system 102 can identify the appropriate best practice workflow by matching such a project with a category directed to obtaining a job in the chemical engineering industry.

In step 703, best practice workflow system 102 reports key performance indicators associated with the best practice provided to the user of client device 101. For example, if best practice workflow system 102 provided best practice workflow 400 to the user of client device 101, then best practice workflow system 102 may report the following key performance indicators in connection with best practice workflow 400: average job was successfully found in 90 days using workflow 400, average out of pocket expense spent on the job search was between $100-$200 using workflow 400 and average number of days for travel required for job hunting using workflow 400 was 2-3 days.

In step 704, best practice workflow system 102 receives an indication from the user of a particular task in the best practice workflow that the user is currently executing. For example, referring to FIG. 4, user of client device 101 may indicate that the user is currently executing step 401 of best practice workflow 400 directed to contacting the AICHE network on LinkedIn® and creating a profile.

In step 705, best practice workflow system 102 recommends the next task in the workflow to be completed by the user in the process for completing the project based on the task in the workflow the user is currently executing along with task related key performance indicators. For example, referring to FIG. 4, best practice workflow system 102 may identify alternative tasks 402, 403 and 404 as the next tasks or steps that should be accomplished in completing the project. In one embodiment, the next task that is recommended by best practice workflow system 102 corresponds to the task that is graphically connected to the task in the best practice workflow the user is currently executing.

In step 706, best practice workflow system 102 receives an indication from the user that the next recommended task (provided in step 705) was completed.

In step 707, a determination is made by best practice workflow system 102 as to whether there are any more tasks to be completed to complete the project. If there are no more tasks to be completed to complete the process, then, in step 708, best practice workflow system 102 provides an indication to the user that the project is completed.

Otherwise, if there are more tasks to be completed to complete the project, then best practice workflow system 102 recommends the next task in the workflow to be completed by the user in the process for completing the project in step 705.

In some implementations, method 700 may include other and/or additional steps that, for clarity, are not depicted. Further, in some implementations, method 700 may be executed in a different order presented and that the order presented in the discussion of FIG. 7 is illustrative. Additionally, in some implementations, certain steps in method 700 may be executed in a substantially simultaneous manner or may be omitted.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for providing a best practice workflow to aid a user in completing a project, the method comprising:
receiving practice instances for completing said project from a first plurality of users, wherein each of said practice instances comprises a graph of nodes and directed edges, wherein each of said nodes represents a task in a process for completing said project and each of said directed edges illustrates an execution sequence between two tasks;
receiving a plurality of rankings for each of said practice instances from a second plurality of users;
computing a single ranking for each of said practice instances based on said received rankings from said second plurality of users; and
generating, by a processor, said best practice workflow for completing said project based on practice instances whose single ranking exceeds a threshold, wherein said best practice workflow comprises a plurality of tasks in said process for completing said project and edges between tasks indicating control flow between said tasks.

2. The method as recited in claim 1, wherein said best practice workflow for completing said project is generated based on said practice instances whose single ranking exceeds said threshold using a process mining technique.

3. The method as recited in claim 1, wherein said single ranking for a practice instance is computed based on a weighted average of a plurality of rankings for said practice instance received from a third plurality of users.

4. The method as recited in claim 1 further comprising:
storing said practice instances whose single ranking exceeds said threshold.

5. The method as recited in claim 1 further comprising:
extracting performance indicators from said practice instances used to generate said best practice workflow to compute one or more of an average, a median and standard deviation values for each of said extracted performance indicators for said best practice workflow.

6. The method as recited in claim 5, wherein one or more tasks in said best practice workflow are associated with one or more performance indicators based on said extracted performance indicators.

7. The method as recited in claim 1 further comprising:
receiving an additional practice instance for completing said project after said best practice workflow is generated.

8. The method as recited in claim 7 further comprising:
receiving a plurality of rankings for said additional practice instance from a third plurality of users; and
computing a single ranking for said additional practice instance based on said received rankings from said third plurality of users.

9. The method as recited in claim 8 further comprising:
updating said best practice workflow for completing said project in response to said single ranking for said additional practice instance exceeding said threshold.

10. The method as recited in claim 9 further comprising:
storing said additional practice instance in a set of stored practice instances in response to said single ranking for said additional practice instance exceeding said threshold; and
removing a previously stored practice instance in said set of stored practice instances in response to said storing of said additional practice instance.

11. The method as recited in claim 10 further comprising:
updating said best practice workflow for completing said project using said set of stored practice instances.

12. The method as recited in claim 11 further comprising:
extracting performance indicators from said set of stored practice instances to compute one or more of an average, a median and standard deviation values for each of said extracted performance indicators for said updated best practice workflow.

13. The method as recited in claim 1 further comprising:
receiving a request from a user for identifying said best practice workflow for completing said project;
identifying and providing said best practice workflow for completing said project to said user;
receiving an identification of a task of said best practice workflow said user is currently executing; and
recommending a next task to be completed by said user in said process for completing said project based on said task of said best practice workflow said user is currently executing.

14. The method as recited in claim 13, wherein said next task recommended to be completed by said user is connected to said task in said best practice workflow said user is currently executing.

15. The method as recited in claim 13 further comprising:
recommending a second next task in said best practice workflow to be completed by said user in said process for completing said project upon receiving an indication that said next task was completed by said user.

16. The method as recited in claim 13 further comprising:
reporting performance indicators associated with said best practice workflow in connection with providing said best practice workflow to said user.
